(19) United States
(12) Patent Application Publication
(10) Pub. No.: US 2012/0316870 A1
(43) Pub. Date: Dec. 13, 2012

(54) COMMUNICATION DEVICE WITH SPEECH RECOGNITION AND METHOD THEREOF

(75) Inventors: YING-CHUAN YU, Tu-Cheng (TW); YING-XIONG HUANG, Tu-Cheng (TW)

(73) Assignee: HON HAI PRECISION INDUSTRY CO., LTD., Tu-Cheng (TW)

(21) Appl. No.: 13/216,267

(22) Filed: Aug. 24, 2011

(30) Foreign Application Priority Data
Jun. 7, 2011 (TW) 100119726

(51) Int. Cl. G10L 15/00

(52) U.S. Cl. 704/231; 704/E15.001

(57) ABSTRACT

A communication unit, a voice input unit, a storage unit, and a processor are included in a communication device. The communication unit enables communication between the device and other communication devices. The voice input unit receives voice signals, which may correspond to one stored speech command and an related operation. The processor detects a match, and executes the desired operation. A related communication method is also provided.

### BACKGROUND

1. Technical Field

The present disclosure relates to communication devices and, particularly, to a communication device capable of executing communication operations based on speech recognition and communication method thereof.

2. Description of Related Art

Commonly, when a communication device, for example a mobile phone, receives an incoming call, a user can press an answer button or touch an answer icon displayed on a touch-sensitive screen to answer the call. This conventional method of answering a call depends on physical action by the user, which may be troublesome if it is not convenient to answer the call, for example, if the user is driving.

Therefore, it is desirable to provide a communication device and a communication method thereof to solve the problems mentioned above.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a block diagram of a communication device in accordance with an exemplary embodiment.

FIG. 2 is a flowchart of a communication method in accordance with an exemplary embodiment.

### DETAILED DESCRIPTION

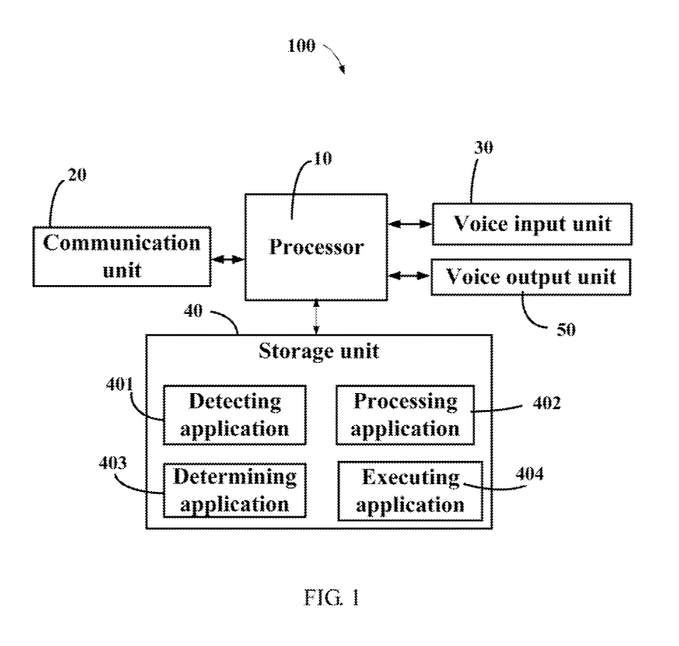

Referring to FIG. 1, a communication device 100 includes a processor 10, a communication unit 20, a voice input unit 30, a storage unit 40, and a voice output unit 50. The communication unit 20 enables communication between the device 100 and other communication devices (not shown). The communication device 100 may be a mobile phone. The voice input unit 30 receives voice signals, and the voice input unit 30 may be a microphone. The storage unit 40 stores a first relationship between speech commands and communication operations. Each command corresponds to one operation. In this embodiment, the speech command “OK” or “Yes” corresponds to “answer the call”, and a speech command “No” corresponds to “reject the call”. The relationship between speech commands and communication operations may be recorded in different ways, for example, the relationship may be recorded in a table (shown below).

| SPEECH COMMANDS | COMMUNICATION OPERATIONS |
|---|---|
| OK | Answer the call |
| Yes | Answer the call |
| No | Reject the call |
| . . . | . . . |

The storage unit 40 further stores a detecting application 401, a processing application 402, a determining application 403, and an executing application 404. The detecting application 401 includes various software components which may be implemented by the processor 10 to detect when the device 100 receives an incoming call from another communication device. The processing application 402 includes various software components which may be implemented by the processor 10 to process voice signals received from the voice input unit 30 to identify and determine a spoken command when the device 100 receives an incoming call. The determining application 403 includes various software components which may be implemented by the processor 10 to determine whether the recognized spoken command matches a speech command stored in the storage unit 40, and if a match is determined, further to determine an operation corresponding to the matched speech command according to the first relationship. The executing application 404 includes various software components which may be implemented by the processor 10 to execute the operation so determined. For example, if the determined speech command is “OK” or “Yes”, the device 100 determines that the user wishes to answer the call, thus the device 100 answers the call. In this embodiment, when the device 100 answers the call, the device 100 enters a handfree mode, thus the user can talk without picking up the communication device 100.

The storage unit 40 further stores a second relationship between telephone numbers and personal information. Personal information corresponding to one telephone number may include a name, a group or category the name belongs to, and other information. The detecting application 401 is further implemented by the processor 10 to determine the telephone number of a caller. The determining application 403 is further implemented by the processor 10 to retrieve personal information corresponding to the telephone number of the caller according to the second relationship, when an incoming call is received. The executing application 404 is further implemented by the processor 10 to output information concerning the personal information through the voice output unit 50. For example, if the stored personal information corresponding to the telephone number “1234” is “Jack, family”, when the communication unit 20 receives an incoming call from the telephone number “1234”, the executing application 404 outputs a spoken statement “your family Jack is calling you”.

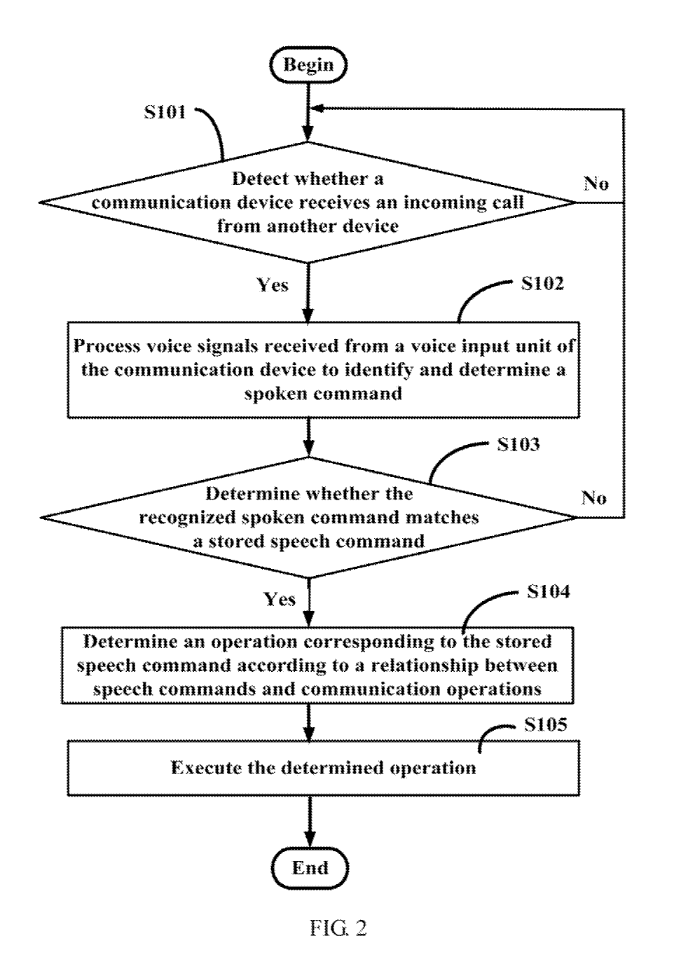

Referring to FIG. 2, a flowchart of a communication method used in the communication device 100 is shown.

In step S101, the detecting application 401 is implemented by the processor 10 to detect when the device 100 receives an incoming call from another communication device. When it does, the procedure goes to step S102. Until it does, the detecting application 401 is implemented by the processor 10 to continue to execute the step S101.

In step S102, the processing application 402 is implemented by the processor 10 to process voice signals received from the voice input unit 30, to identify and determine a spoken command.

In step S103, the determining application 403 is implemented by the processor 10 to determine whether the recognized spoken command matches a speech command stored in the storage unit 40. If there is a match, the procedure goes to step S404, if not, the procedure returns to step S101.

In step S104, the determining application 403 is further implemented by the processor 10 to determine the operation which corresponds to the stored speech command according to the first relationship.

In step S105, the executing application 404 is implemented by the processor 10 to execute the determined operation.

In this embodiment, the communication method further includes the following steps. When an incoming call is answered, the determining application 401 is further implemented to determine the telephone number of the caller, and the determining application 403 is further implemented to retrieve personal information corresponding to the telephone number of the caller, according to the second relationship, and the executing application 404 is further implemented to output information concerning the personal information through the voice output unit 50.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A communication device with speech recognition, comprising:
a communication unit for enabling communications between the communication device and other communication devices;
a voice input unit to receive voice signals;
a storage unit storing a plurality of applications and a first relationship between speech commands and communication operations, each speech command corresponding to one of the communication operations; and
a processor to execute the plurality of applications, wherein the plurality of applications comprise instructions executable by the processor to:
detect when the communication device receives an incoming call from another communication device;
process voice signals received from the voice input unit to identify and determine a spoken command when the communication device receives an incoming call;
determine whether the determined spoken command matches one of the speech commands stored in the storage unit, and if a match is determined, further determine a communication operation corresponding to the matched speech command according to the first relationship; and
execute the determined communication operation.

2. The communication device with speech recognition as described in claim 1, wherein the communication operation comprises an operation of answering the incoming call and an operation of rejecting the incoming call.

3. The communication device with speech recognition as described in claim 1, wherein the plurality of applications further comprise instructions executable by the processor to control the communication device to enter a handfree mode when the incoming call is answered.

4. The communication device with speech recognition as described in claim 1, wherein the storage unit further stores a second relationship between telephone numbers and personal information, the plurality of applications further comprises instructions executable by the processor to determine a telephone number of a caller when receiving an incoming call, retrieve personal information corresponding to the telephone number of the caller according to the second relationship, and output information concerning the determined personal information.

5. A communication method applied in a communication device, the communication device comprising a communication unit for enabling communications between the communication device and other communication devices, a voice input unit to receive voice signals, and a storage unit storing a first relationship between speech commands and communication operations, each speech command corresponding to one of the communication operations, the communication method comprising:
detecting when the communication device receives an incoming call from another communication device;
processing voice signals received from the voice input unit to identify and determine a spoken command when the communication device receives an incoming call;
determining whether the determined spoken command matches one of the speech commands stored in the storage unit, and if a match is determined, further determining a communication operation corresponding to the matched speech command according to a first relationship; and
executing the determined communication operation.

6. The communication method as described in claim 5, wherein the communication operation comprises an operation of answering the incoming call and an operation of rejecting the incoming call.

7. The communication method as described in claim 5, wherein the communication method further comprising:
determining a telephone number of a caller when receiving an incoming call;
retrieving personal information corresponding to the telephone number of the caller according to a second relationship between telephone numbers and personal information; and
outputting information concerning the determined personal information.
